(19) United States
(12) Patent Application Publication
(10) Pub. No.: US 2024/0231408 A1
(43) Pub. Date: Jul. 11, 2024

(54) DIGITAL MAXIMUM POWER POINT TRACKING

(71) Applicant: Atmosic Technologies, Inc., Campbell, CA (US)

(72) Inventors: Dimitrios Filippos Papadopoulos, San Jose, CA (US); Manolis Terrovitis, Athens (GR); Bita Nezamfar, Los Altos, CA (US)

(73) Assignee: Atmosic Technologies, Inc., Campbell, CA (US)

(21) Appl. No.: 18/543,801

(22) Filed: Dec. 18, 2023

Related U.S. Application Data
(60) Provisional application No. 63/437,211, filed on Jan. 5, 2023.

(51) Int. Cl. G05F 1/67

(52) U.S. Cl. CPC G05F 1/67

(57) ABSTRACT

Systems and methods for energy harvesting are disclosed. An example method is performed by a computing device coupled to an energy harvesting circuit and includes identifying a first time period required for the energy harvesting circuit to complete a first number of energy extraction events, the first time associated with an initial harvest voltage, determining a first value of an estimated extracted power based on the initial harvest voltage and the first number of energy extraction events, and iteratively adjusting the harvest voltage and determining the optimal harvest voltage based at least in part on values of the estimated extracted power value corresponding to the adjusted harvest voltage.

### CROSS-REFERENCE TO RELATED APPLICATIONS

This Patent Application claims priority to U.S. Provisional Patent Application No. 63/437,211 entitled “DIGITAL MAXIMUM POWER POINT TRACKING” and filed on Jan. 5, 2023, which is assigned to the assignee hereof. The disclosures of all prior Applications are considered part of and are incorporated by reference in this Patent Application.

### TECHNICAL FIELD

This disclosure relates generally to circuits and techniques for energy harvesting, and more specifically to maximum power point tracking for energy harvesting.

### BACKGROUND OF RELATED ART

A number of electronic circuits may harvest energy from an energy source, such as harvesting energy generated by solar panels, harvesting energy from wind turbines, from radio frequency signals, and so on. Depending on the energy source, and on related conditions, a circuit configured for harvesting such energy should be configured differently for most efficient operations. For example, such a circuit may be configured to maximize energy extraction as such conditions vary. This may be referred to as maximum power point tracking.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a method for identifying an optimal harvest voltage associated with a maximum extracted energy for an energy harvesting circuit. An example method may be performed by computing device coupled to an energy harvesting circuit and include identifying a first time period required for the energy harvesting circuit to complete a first number of energy extraction events, the first time associated with an initial harvest voltage, determining a first value of an estimated extracted power based on the initial harvest voltage and the first number of energy extraction events, and iteratively adjusting the harvest voltage and determining the optimal harvest voltage based at least in part on values of the estimated extracted power value corresponding to the adjusted harvest voltage.

In some aspects, iteratively adjusting the harvest voltage includes incrementing the harvest voltage by a predetermined value, identifying a second number of energy extraction events occurring within the first time period, the second number of energy extraction events based on the incremented harvest voltage, determining a second value of the estimated extracted power based on the incremented harvest voltage, and determining the optimal harvest voltage based at least in part on the second value of the estimated extracted power

In some aspects, determining the optimal harvest voltage further includes, if the second value of the estimated extracted power exceeds the first value of the estimated extracted power, further incrementing the incremented harvest voltage by the predetermined value, wherein the optimal harvest voltage is determined based at least in part on the further incremented harvest voltage.

In some aspects, determining the optimal harvest voltage further includes, if the second value of the estimated extracted power is less than the first value of the estimated extracted power, decrementing the incremented harvest voltage by twice the predetermined value, wherein the optimal harvest voltage is determined based at least in part on the twice decremented harvest voltage. In some aspects, the method further includes determining a third value of the estimated extracted power based at least in part on the twice decremented harvest voltage and comparing the third value of the estimated extracted power to the second value of the estimated extracted power. In some aspects, in response to the third value of the estimated extracted power exceeding the second value of the estimated extracted power, the method further includes incrementing the twice decremented harvest voltage by the predetermined value and identifying the incremented twice decremented harvest voltage as the optimal harvest voltage. In some aspects, the method further includes, in response to the second value of the estimated extracted power exceeding the third value of the estimated extracted power, further decrementing the twice decremented harvest voltage, and determining a fourth value of the estimated extracted power based at least in part on the further decremented harvest voltage, where the optimal harvest voltage is determined based at least in part on the fourth value of the estimated extracted power.

In some aspects, determining the optimal harvest voltage further includes identifying a third number of energy extraction events occurring within the first time period, the third number of energy extraction events based at least in part on the optimal harvest voltage, where the method further includes periodically determining a fourth number of energy extraction events based at least in part on the optimal harvest voltage. In some aspects, in response to the fourth number of energy extraction events being within a predetermined threshold number of the third number of energy extraction events, the method further includes determining that the optimal harvest voltage remains accurate. In some aspects, the method further includes, in response to the fourth number of energy extraction events not being within a predetermined threshold number of the third number of energy extraction events, determining that the optimal harvest voltage has changed, and determining an updated optimal harvest voltage. In some aspects, the method further includes, prior to determining the first value of the estimated extracted power, determining that the first number of energy extraction events is less than a lower limit, and in response, placing the energy harvesting circuit in a low power state.

In some aspects, the harvest voltage is configured so that an energy extraction event is triggered in response to a harvest voltage exceeding the harvest voltage, wherein the harvest voltage is coupled to an energy source associated with the energy harvesting circuit.

Another innovative aspect of the subject matter described in this disclosure can be implemented as a computing device coupled to an energy harvesting circuit. An example computing device may include one or more processors and a memory storing instructions for execution by the one or more processors. Execution of the instructions causes the computing device to perform operations comprising identifying a first time period required for an energy harvesting circuit to complete a first number of energy extraction events, the first time associated with an initial harvest voltage, determining a first value of an estimated extracted power based on the initial harvest voltage and the first number of energy extraction events, and iteratively adjusting the harvest voltage and determining the optimal harvest voltage based at least in part on values of the estimated extracted power value corresponding to the adjusted harvest voltage.

Another innovative aspect of the subject matter described in this disclosure can be implemented as a non-transitory computer-readable storage medium storing instructions for execution by one or more processors of a computing device coupled to an energy harvesting circuit. Execution of the instructions causes the computing device to perform operations comprising identifying a first time period required for an energy harvesting circuit to complete a first number of energy extraction events, the first time associated with an initial harvest voltage, determining a first value of an estimated extracted power based on the initial harvest voltage and the first number of energy extraction events, and iteratively adjusting the harvest voltage and determining the optimal harvest voltage based at least in part on values of the estimated extracted power value corresponding to the adjusted harvest voltage.

### BRIEF DESCRIPTION OF THE DRAWINGS

The present embodiments are illustrated by way of example and are not intended to be limited by the figures of the accompanying drawings.

FIG. 1 shows a simple block diagram of an energy harvesting system which may be used with the example implementations.

FIG. 2 shows a block diagram of a conventional energy harvesting circuit.

FIG. 3 shows an example energy harvesting system 300, in accordance with example implementations.

FIG. 4A shows an example plot of the current through the inductor of FIG. 3, in accordance with some implementations.

FIG. 4B shows an example plot of the voltage at a first terminal of the inductor 313 shown in FIG. 3.

FIG. 4C shows an example plot of the voltage at a second terminal of the inductor 313 shown in FIG. 3.

FIG. 5 shows an example circuit for generating control signals for the transistors of FIG. 3, in accordance with example implementations.

FIG. 6 shows an illustrative flow chart depicting an example operation for identifying an optimal harvest voltage, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present disclosure, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

Various implementations relate generally to the configuration of energy harvesting circuits for maximizing energy extraction in light of changing conditions. For example, such energy harvesting circuits may harvest energy from energy sources such as solar panels, from radio frequency signals, from wind turbines, and so on. In some implementations, such configurations may include selection of an appropriate harvest voltage for triggering energy extraction events. Such a harvest voltage may refer to a threshold value of an output from an energy source which is sufficient to trigger such an energy extraction event. The harvest voltage should be set to an optimal value in order to maximize energy extraction from the energy source. Appropriate selection of the harvest voltage corresponds to maximum power point tracking. For example, based on a number of energy extraction events detected for a given harvest voltage, and on calculation of an associated estimated extracted power, the harvest voltage may be iteratively adjusted in order to identify an optimal harvest voltage for the energy harvesting circuit. These techniques are discussed in more detail below.

Particular implementations of the subject matter described in this disclosure can be implemented to realize one or more of the following potential advantages. In some implementations, energy harvesting circuits may be calibrated without disrupting energy harvesting operations. For example, conventional techniques may disconnect the energy source from the energy harvesting circuit, couple the energy source to another circuit which may determine optimal configuration. The example techniques avoid wasting input power by not disconnecting the energy source and determining the optimal harvest voltage while energy is still being harvested. Thus, the example techniques enable more efficient calibration and operation of energy harvesting circuits.

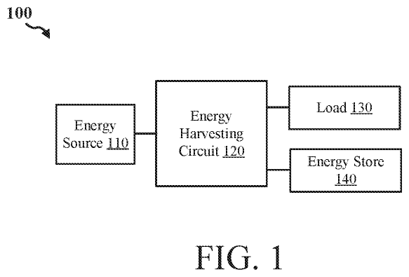

FIG. 1 shows a simple block diagram of an energy harvesting system 100 which may be used with the example implementations. The energy harvesting system 100 includes an energy source 110, an energy harvesting circuit 120, a load 130, and an energy store 140. The energy source may be any suitable source of energy which may be harvested using the energy harvesting circuit 120. For example, the energy source 110 may include one or more solar panels, such as photovoltaic or thermophotovoltaic solar panels, one or more wind turbines, one or more sources of radio frequency (RF) energy, and so on. The energy source 110 is coupled to the energy harvesting circuit 120, which may extract energy from the energy source, and may provide this energy to the load 130, where the extracted energy may be immediately used, for example by one or more electronic devices coupled to the energy harvesting system 100. Alternatively, the extracted energy may be provided to the energy store 140, where the energy may be stored for later use, such as in a battery or another energy storage device.

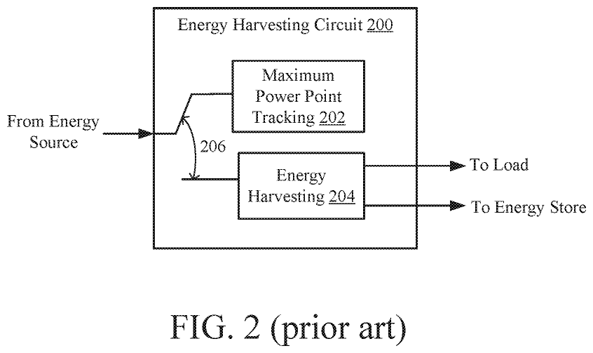

FIG. 2 shows a block diagram of a conventional energy harvesting circuit 200. The conventional energy harvesting circuit 200 may be coupled to an energy source, such as the energy source 110 of FIG. 1. This energy source may either be coupled to a maximum power point tracking (MPPT) module 202, or to an energy harvesting module 204 of the conventional energy harvesting circuit 200. For example, the energy source may be coupled to either the MPPT module 202 or the energy harvesting module 204 using the switch 206. When the conventional energy harvesting circuit 200 is to be calibrated, the switch 206 may couple the energy source to the MPPT module 202. The MPPT module 202 may determine one or more configurations for the energy harvesting circuit 200 based on signals received from the energy source. For example, the MPPT module 202 may identifying an optimal voltage for energy extraction based on the open circuit voltage of the energy source, such as determining the optimal voltage to be a fraction of the open circuit voltage, or as another predetermined proportion or function of the open circuit voltage of the energy source. This optimal voltage may then be applied for configuring the energy harvesting module 204. The switch 206 may then couple the energy source to the energy harvesting module 204 for energy extraction using this optimal voltage. The energy harvesting module may apply the harvested energy to the load or the energy store.

As discussed above, conventional techniques for calibrating energy harvesting devices, such as described above with respect to FIG. 2, must disrupt energy harvesting operations in order to determine optimal calibration, such as by determining an optimal voltage for maximum power point tracking. For example, in the conventional energy harvesting circuit 200, the switch 206 may interrupt energy harvesting in order to couple the MPPT module 202 to the energy source. Aspects of the present disclosure may avoid such disruption and interruption by enabling an energy harvesting circuit to be calibrated, that is, an appropriate harvest voltage selected for optimal power extraction, without interrupting energy harvesting operations.

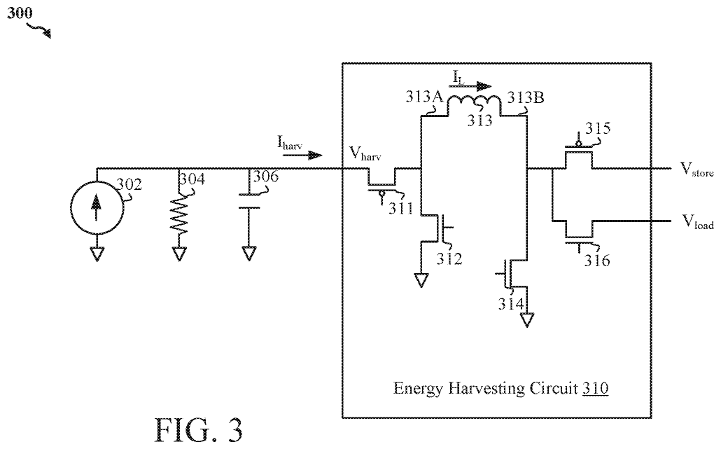

FIG. 3 shows an example energy harvesting system 300, in accordance with example implementations. The energy harvesting system 300 is shown to include an input current source 302, an input resistor 304, an input capacitor 306, and an energy harvesting circuit 310. The input current source 302, input resistor 304, and input capacitor 306 may represent an output from an energy source coupled to the energy harvesting system 300, such as the energy source 110 of FIG. 1. The input current source 302, input resistor 304, and input capacitor 306 correspond to a harvest current Iₕₐᵣᵥ and a harvest voltage Vₕₐᵣᵥ at an input to the energy harvesting circuit 310. This input is at a first terminal of a first transistor 311. A second terminal of the first transistor 311 is coupled to a first terminal of a second transistor 312. A second terminal of the second transistor 312 may be coupled to ground. The second terminal of the first transistor 311 and the first terminal of the second transistor 312 may also be coupled to a first terminal 313A of an inductor 313. A current through the inductor 313 may be called I_{L}. A second terminal 313B of the inductor 313 may be coupled to a first terminal of a third transistor 314. A second terminal of the third transistor 314 may be coupled to ground. The second terminal 313B and the first terminal of the third transistor 314 may also be coupled to a first terminal of a fourth transistor 315 and a first terminal of a fifth transistor 316. A second terminal of the fourth transistor 315 may be coupled to an energy storage circuit and may have a voltage Vₛₜₒᵣₑ. A second terminal of the fifth transistor 316 may be coupled to a load circuit and may have a voltage V_{load}.

Note that while the inductor 313 is shown as a part of the energy harvesting circuit 310, that in some implementations, the inductor 313 may be external to the energy harvesting circuit 310. That is, the terminals 313A and 313B may couple an external inductor 313 to the energy harvesting circuit 310.

Further, the transistors 311, 312, 314, 315, and 316 may be any suitable transistor, such as a bipolar junction transistor (BJT), a metal oxide semiconductor field effect transistor (MOSFET), a junction gate field effect transistor (JFET), and so on. Further, while the gate or base terminal of each of these transistors is shown to be noninverted or inverted, that in some other implementations, such inversion may be reversed, and that any of the transistors 311, 312, 314, 315, and 316 may have an inverted or a noninverted input at their respective gate or base terminal.

Aspects of the present disclosure may measure power received from the energy source based on a sequence of energy harvesting events, (subsequently “events”). Such events are based on a comparison of Vₕₐᵣᵥ and a threshold voltage, such as a reference voltage output from a reference voltage generator. That is, an event is triggered when Vₕₐᵣᵥ exceeds this reference voltage. In other words, the “harvest voltage” is the voltage at Vₕₐᵣᵥ sufficient to trigger such an event. These events may include two stages, an energize stage, energizing the inductor 313, and a dump stage, where the energy in the inductor 313 is sent to the energy storage circuit. In response to the triggering of such an event, while the energy harvesting circuit 310 is operating in buck-boost mode, current may be allowed to flow through the transistor 311 (that is, from the first terminal to the second terminal of the transistor 311), through the inductor 313, and through the transistor 314 to ground. This is the energize stage and may have a duration of Ten. During the energize stage, no current may flow through the transistor 312 or the transistors 315 or 316. After Ten, the dump stage may be triggered, allowing no current to flow through the transistors 311, 314, or 316, and instead allowing current flow through the transistor 312, through the inductor 313, and through the transistor 315. Thus, during the energize stage, current increases through the inductor 313, and during the dump stage, power is sent to the energy storage system through the transistor 315.

Note that while the energy extraction circuit 310 is operating in buck-boost mode, that the efficiency of the dump stage in sending harvested power to the energy storage circuit may be impaired. For example, in buck-boost mode, this efficiency may be decreased by roughly 10% or 20% as compared to operating in buck or boost modes. However, this energy loss is less than that associated with conventional circuits, which must decouple the energy source from the energy storage entirely in order for calibration. Further, the energy extraction circuit may operate in buck-boost mode only for identifying the optimal harvest voltage, further limiting the loss in efficiency.

Note that the events are described above in terms of their relevance for calibration of the energy harvesting circuit 310, and so no power is sent to the load. In normal operation, rather than sending power to the energy storage circuit during the dump stage, for some events power may instead be sent to the load, such as by enabling current to pass through the transistor 316 instead of the transistor 315.

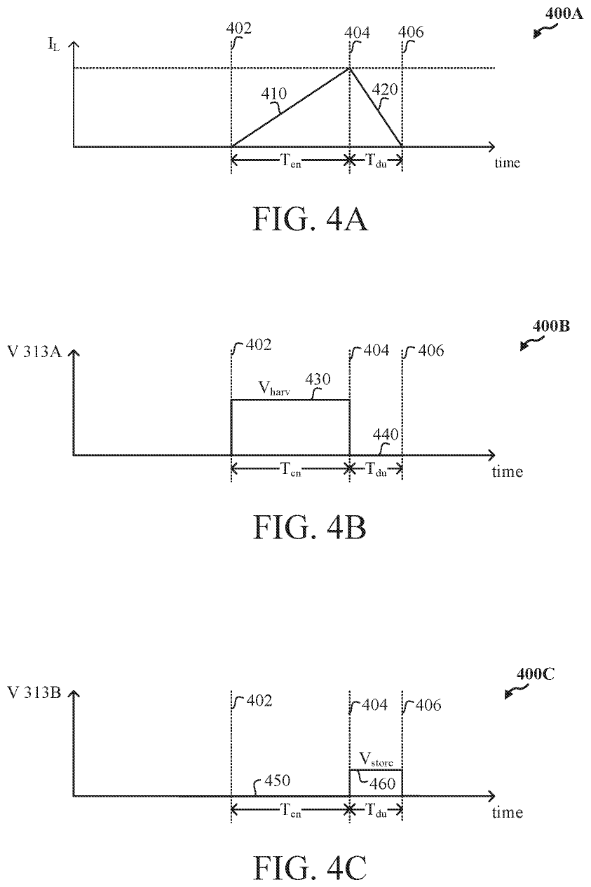

FIG. 4A shows an example plot 400A of the current through the inductor 313 of FIG. 3, in accordance with some implementations. At a time 402, an event is triggered, beginning an energize stage lasting a time Ten until the time 404, when the dump stage is triggered, lasting a time Tdu until the time 406 when the event concludes. During the energize stage, the current I_{L} through the inductor 313 follows a line 410 increasing along a slope Vₕₐᵣᵥ/L until time 404. During the dump stage, the current I_{L} decreases along a line 420 having a slope of −Vₛₜₒᵣₑ/L until time 406. FIG. 4B shows an example plot 400B of the voltage at a first terminal 313A of the inductor 313 shown in FIG. 3. During the energize stage, the voltage 430 at the terminal 313A has a value of Vₕₐᵣᵥ, while during the dump stage the voltage 440 at terminal 313A has a value of roughly zero. This is because during the energize stage, the terminal 313A is coupled to Vₕₐᵣᵥ through the transistor 311, while during the dump stage, the terminal 313A is coupled to ground via the transistor 312. FIG. 4C shows an example plot 400C of the voltage at a second terminal 313B of the inductor 313 shown in FIG. 3. During the energize stage, the voltage 450 at terminal 313B has a value of roughly zero, as it is coupled to ground via the transistor 314, while during the dump stage, the voltage 460 at terminal 313B has a value of Vₛₜₒᵣₑ, as it is coupled to the energy storage circuit via the transistor 315.

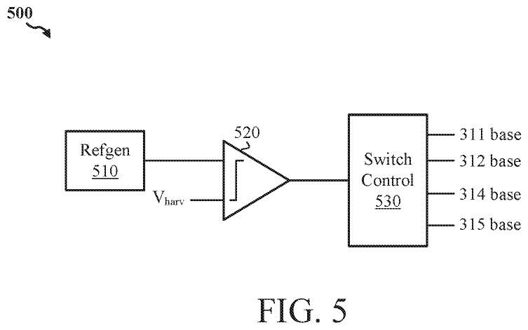

FIG. 5 shows an example circuit 500 for generating control signals for the transistors 311, 312, 314, and 316 of FIG. 3, in accordance with example implementations. FIG. 5 shows a reference generator (“refgen”) 510, which generates a reference voltage for input to a comparator 520, which also receives Vₕₐᵣᵥ as input. This reference voltage is one example of the threshold voltage described above, where an energy extraction event is triggered when the harvest voltage Vₕₐᵣᵥ exceeds the reference voltage. The refgen 510 may be a fast refgen, which may not ordinarily be required, but which may be enabled when determining the optimal configuration for the energy harvesting circuit 310 of FIG. 3. The comparator 520 outputs a first signal when the reference voltage exceeds Vₕₐᵣᵥ, and a second signal when Vₕₐᵣᵥ exceeds the reference voltage. The comparator 520 is coupled to a switch control 530, which generates signals for the base or gate terminals of transistors 311, 312, 314, and 315 for triggering events, and for switching between energize and dump stages during such events. In response to the second signal, the switch control 530 generates signals for controlling the transistors of FIG. 3 to operate in the energize and dump stages, as discussed above. Thus, as the reference voltage varies, so too does the harvest voltage level required to trigger an event.

When the energy harvesting circuit 310 is operating in buck boost mode, the instantaneous input power may be expressed as P=Vₕₐᵣᵥ*Iₕₐᵣᵥ. From this equation, the extracted power may be

$$P = V harv * Q * \frac{N}{T}$$

where Q is the amount of charge harvested for each event, N is the number of events within a time T, and T is the time interval during which the power is calculated. P may further be written as

$$P = V harv * ( 1 / 2 ) {T}_{en} * I max * N / T$$

where Ten is the energize time and Imax is the maximum current through the inductor 313. Further expanding this equation, we have

$$P = V harv * ( 1 / 2 ) {T}_{en} * ( \frac{V harv}{L} {T}_{en} ) * \frac{N}{T} = {V harv}^{2} * N * c$$

where c is a constant. Thus Pestimate=Vharv²*N may be an accurate metric for estimating power harvested by the energy harvesting circuit 310 of FIG. 3, while the exact delivered power may be given as

$$P = ( \frac{P estimate}{T} ) * ( \frac{{Ten}^{2}}{2 L} ) .$$

In accordance with example implementations, identifying an optimal value of the harvest voltage may include measuring N for a plurality of values of the harvest voltage, and identifying the value of the harvest voltage which maximizes Pestimate. During such operations, the time T must be selected to be sufficiently long such that enough events occur, to avoid approximation errors, but also to be short enough that not so many events occur that the energy storage circuit charges too quickly. Further, as discussed in more detail below, there may be a plurality of allowed values of the harvest voltage, such that incrementing or decrementing the reference voltage provided to the comparator 520 corresponds to increasing or decreasing the harvest voltage to its next allowed value. As discussed below, the number of such allowed values may vary based on search operations in order to limit the number of allowed values of the harvest voltage which are determined to be unlikely to be the optimal values.

In some aspects, an example search operation may identify an optimal harvest voltage. Such an example search operation may be performed for example by one or more processors of a computing device coupled to the energy harvesting circuit 310. The operation may begin with an initial harvest voltage. Such an initial harvest voltage may for example be an initial reference voltage generated by refgen 510. In some aspects, this initial reference voltage must be less than or equal to an open circuit voltage of the energy source. For example, if a solar panel has an open circuit voltage of 1.2 V, then the initial reference voltage must be no larger than 1.2 V. The initial extraction event voltage may be a predetermined default value of the harvest voltage. In some aspects, the search operation may begin with enabling the refgen 510 and waiting for the refgen 510 to settle at the initial harvest voltage.

The search operation determines a time T required for a predetermined number of events to occur. For example, the predetermined number of events may be 200, or another suitable number of events selected to ensure accurate measurements but to avoid charging the energy storage circuit too quickly. If the time exceeds a threshold time, then insufficient energy is present from the energy source for calibration to occur, and the search operation may end. In some aspects, the search operation may be delayed for a predetermined amount of time, and then the time required for the predetermined number of events may be gauged again. In some aspects, the energy harvesting circuit may enter a low power state until the predetermined amount of time has elapsed, as this indicates there is insufficient energy for harvesting operations.

After a suitable time T for the predetermined number of events has been determined, the search operation may continue. A first estimated extracted power may then be determined based on the initial harvest voltage and the number of events occurring within the time T. For example, the first estimated extracted power may be determined based on the metric Pestimate described above, where Pestimate=Vharv²*N, and N is the number of events occurring within the time T.

The harvest voltage is then incremented to its next allowed value. The operation determines the number of events which occur within the time T, and a second estimated extracted power is determined and compared to the first estimated extracted power. If the second estimated extracted power exceeds the first estimated extracted power, then the harvest voltage is further incremented to its next allowed value. The search continues, determining the number of events occurring within the time T at this further incremented harvest voltage, and determined a third estimated extracted power. If the estimated extracted power is still increasing, that is, if the third estimated extracted power exceeds the second estimated extracted power, then the search operation continues, further incrementing the harvest voltage, determining the corresponding numbers of events the estimated extracted powers. If a maximum allowed value of the harvest voltage is reached, then it is selected as the optimal harvest voltage and the search operation ends.

If at any step, that is at any value of the harvest voltage, the estimated extracted power is less than at a previous value of the harvest voltage, then, rather than incrementing the harvest voltage, the harvest voltage may be decremented twice. That is, the harvest voltage may be decreased to an allowed value two steps below it. For example, if each increment of the threshold harvest voltage is separated by 0.4 V, then decrementing the harvest voltage twice would correspond to decreasing the harvest voltage by 0.8 V. After twice decrementing the harvest voltage, the corresponding number of events and the estimated extracted power may be determined again.

If the estimated extracted power corresponding to this twice decremented harvest voltage is greater than the previously calculated estimated extracted power, then the search operation may continue in the opposite direction. That is, rather than incrementing the harvest voltage, the harvest voltage may be decremented to its next lowest value. The number of events and the estimated extracted power may continue to be determined in this manner until the estimated extracted power is less than determined for a previous value of the harvest voltage. When this occurs, the harvest voltage may be incremented, and this incremented harvest voltage may be identified as the optimal harvest voltage. This sequence of operations corresponds to determining that the local maximum extracted power is at a lower harvest voltage lower than its current value.

If the estimated extracted power corresponding to the twice decremented harvest voltage is less than the previously calculated estimated extracted power, then this twice decremented harvest voltage may be incremented, and determined to be the optimal harvest voltage.

After the optimal harvest voltage has been determined, in some implementations the circuit which generates the reference voltage, such as the refgen 510, may be disabled, and one or more circuits for performing the search operation may enter a low power state. For example, the one or more circuits may enter the low power state for a predetermined amount of time. Periodically, the one or more circuits for performing the search operation may exit the low power state in order to verify that the determined optimal harvest voltage is still accurate.

For example, such verification includes determining a number of events which occur in the time T at the determined harvest voltage. If this determined number of events is within a threshold number of events (or within a threshold proportion) of the number of events measured for the optimal harvest voltage during the previous search operation, then the optimal harvest voltage is determined to remain accurate. In this case, no updates to the harvest voltage are required, and the one or more circuits may reenter the low power state.

If the number of events which occur during the time T at the determined harvest voltage has changed more than the threshold number of events, then a correction operation may be performed. For example, the harvest voltage may be incremented from the previously determined value, and a current value of the estimated extracted power, such as a current value of Pestimate, determined for the incremented harvest voltage. If this current value of the estimated extracted power exceeds that measured for the optimal harvest voltage during the previous search operation, then search operations may continue in this direction. That is, the harvest voltage may continue to be incremented, and the search operations described above continued until a new optimal value of the harvest voltage is determined.

If the current value of the estimated extracted power for this incremented harvest voltage is lower than the estimated extracted power determined during the previous search operation, then search operations may continue in the negative direction to find the harvest voltage associated with the next local maximum of Pestimate. That is, the harvest voltage may be decremented, the estimated extracted power calculated for the decremented harvest voltage and compared with the current value of the estimated extracted power. If the estimated extracted power continues to increase as the harvest voltage is decremented, such operations continue until a maximum value of the estimated extracted power is determined.

If the estimated extracted power is lower for both the incremented harvest voltage (as compared to the previously determined optimal value of the harvest voltage) and the decremented harvest voltage, search operations may restart. That is, such a result indicates that conditions for the energy source have substantially changed, such that the time period T is no longer accurate. In such a scenario, the search operation described above may begin again at the step of determining the amount of time required for the predetermined number of events to occur at the initial value of the harvest voltage.

Similarly, if at any step when exiting the low power state, less than a threshold number of events are detected within the time T, or more than a threshold number of events are detected within the time T, then the search operations may also be restarted. Such a result also indicates that conditions for the energy source have substantially changed since the optimal harvest voltage was determined, such that it may no longer be considered valid.

As discussed above, the harvest voltage may have a number of allowable values and determining the optimal value of the threshold harvest voltage may include selecting one allowable value from this number. For example, in some aspects the threshold harvest voltage may have a minimum value of 0.4 V and a maximum value of 2.5V, and may have a number of allowable values, such as 16 values between this minimum and maximum. In some aspects, the number of allowable values between the minimum and the maximum values may be increased or decreased based on the search operation. For example, if the search operation reaches the maximum allowed value of the threshold harvest voltage, this may indicate that steps in the search operation are wasteful, particularly steps on the lower end of the allowable values of the threshold harvest voltage. Consequently, fewer steps in the search operation may lead to the same optimal value of the threshold harvest voltage. Similarly, when the minimum value of the threshold harvest voltage is reached it may indicate finer granularity of the search operation may be beneficial. particularly for lower allowed values of the threshold harvest voltage. Consequently, more steps in the search operation may lead to a more accurate optimal value of the threshold harvest voltage.

In some aspects, a number of rectifiers may be used for generating the reference voltage. In some aspects, each time the search operation reaches the maximum allowed value of the harvest voltage, the number of stages may be decreased by decreasing the number of stages in the rectifier. Similarly, when the search operation reaches the minimum allowed value of the harvest voltage, the number of stages of the rectifier may be increased if not already at a maximum number of stages.

Note that the search operation described above is configured to identify the first local maximum value of the estimated extracted power closest to the initial value (the estimated extracted power associated with the initial value of the harvest voltage). While harvesting sources, such as solar panels, wind turbines, RF, and so on, tend to be monotonic, corresponding to this local maximum value being the global maximum value, in some aspects multiple harvesting sources may be coupled together to a single energy extraction circuit, and may require a more complex search operation. For example, such a more complex search operation may include a coarse and a fine search stage. During the coarse search stage, the algorithm may make large and coarse adjustments to the harvest voltage covering the entire range of allowed values of the harvest voltage. For example, during this coarse search stage only a limited subset of the allowed values of the harvest voltage may be tested, such as one quarter, one third, or another proportion. The fine search stage may more closely examine estimated extracted powers near one or more values of the harvest voltage. For example, if the coarse search stage identifies one value of the harvest voltage associated with the largest estimated extracted power, then the fine search stage may search among all of the allowable values of the harvest voltage near the value identified in the coarse search stage.

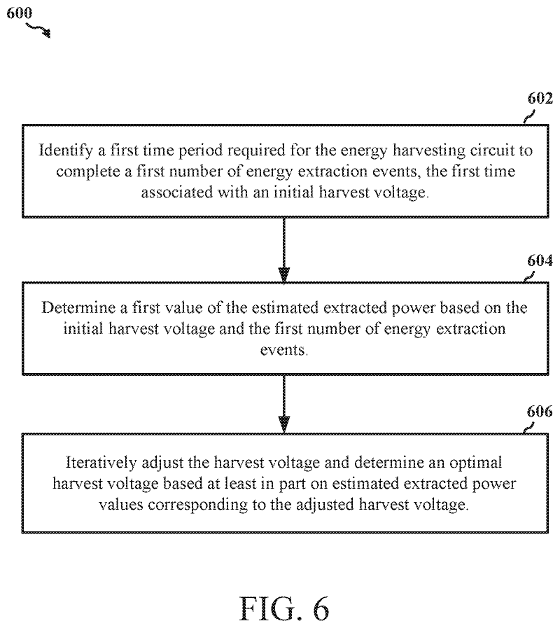

FIG. 6 shows an illustrative flow chart depicting an example operation 600 for identifying an optimal harvest voltage, according to some implementations. The example operation 600 may be performed by one or more processors of a computing device including or coupled to an energy harvesting circuit such as the energy harvesting circuit 310 of FIG. 3. It is to be understood that the example operation 300 may be performed by any suitable systems, computers, or servers.

At block 602, the energy harvesting circuit 310 identifies a first time period required for the energy harvesting circuit to complete a first number of energy extraction events, the first time associated with an initial harvest voltage. At block 604, the energy harvesting circuit 310 determines a first value of an estimated extracted power based on the initial harvest voltage and the first number of energy extraction events. At block 606, the energy harvesting circuit 310 iteratively adjusts the harvest voltage and determines an optimal harvest voltage based at least in part on values of the estimated extracted power corresponding to the adjusted harvest voltage.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for identifying an optimal harvest voltage associated with a maximum extracted energy for an energy harvesting circuit, the method performed by a computing device coupled to an energy harvesting circuit and comprising:
identifying a first time period required for the energy harvesting circuit to complete a first number of energy extraction events, the first time associated with an initial harvest voltage;
determining a first value of an estimated extracted power based on the initial harvest voltage and the first number of energy extraction events; and
iteratively adjusting the harvest voltage and determining the optimal harvest voltage based at least in part on values of the estimated extracted power value corresponding to the adjusted harvest voltage.

2. The method of claim 1, wherein iteratively adjusting the harvest voltage comprises:
incrementing the harvest voltage by a predetermined value;
identifying a second number of energy extraction events occurring within the first time period, the second number of energy extraction events based on the incremented harvest voltage;
determining a second value of the estimated extracted power based on the incremented harvest voltage; and
determining the optimal harvest voltage based at least in part on the second value of the estimated extracted power.

3. The method of claim 2, wherein determining the optimal harvest voltage further comprises:
if the second value of the estimated extracted power exceeds the first value of the estimated extracted power, further incrementing the incremented harvest voltage by the predetermined value, wherein the optimal harvest voltage is determined based at least in part on the further incremented harvest voltage.

4. The method of claim 2, wherein determining the optimal harvest voltage further comprises:
if the second value of the estimated extracted power is less than the first value of the estimated extracted power, decrementing the incremented harvest voltage by twice the predetermined value, wherein the optimal harvest voltage is determined based at least in part on the twice decremented harvest voltage.

5. The method of claim 4, further comprising:
determining a third value of the estimated extracted power based at least in part on the twice decremented harvest voltage; and
comparing the third value of the estimated extracted power to the second value of the estimated extracted power.

6. The method of claim 5, further comprising:
in response to the third value of the estimated extracted power exceeding the second value of the estimated extracted power, incrementing the twice decremented harvest voltage by the predetermined value and identifying the incremented twice decremented harvest voltage as the optimal harvest voltage.

7. The method of claim 5, further comprising:
in response to the second value of the estimated extracted power exceeding the third value of the estimated extracted power, further decrementing the twice decremented harvest voltage; and
determining a fourth value of the estimated extracted power based at least in part on the further decremented harvest voltage, wherein the optimal harvest voltage is determined based at least in part on the fourth value of the estimated extracted power.

8. The method of claim 1, wherein:
determining the optimal harvest voltage further comprises identifying a third number of energy extraction events occurring within the first time period, the third number of energy extraction events based at least in part on the optimal harvest voltage; and
the method further comprises periodically determining a fourth number of energy extraction events occurring within the first time period, the fourth number of energy extraction events based at least in part on the optimal harvest voltage.

9. The method of claim 8, further comprising, in response to the fourth number of energy extraction events being within a predetermined threshold number of the third number of energy extraction events, determining that the optimal harvest voltage remains accurate.

10. The method of claim 8, further comprising, in response to the fourth number of energy extraction events not being within a predetermined threshold number of the third number of energy extraction events, determining that the optimal harvest voltage has changed, and determining an updated optimal harvest voltage.

11. The method of claim 1, further comprising, prior to determining the first value of the estimated extracted power, determining that the first number of energy extraction events is less than a lower limit, and in response, placing the energy harvesting circuit in a low power state.

12. The method of claim 1, wherein the harvest voltage is configured so that an energy extraction event is triggered in response to a harvest voltage exceeding the harvest voltage, wherein the harvest voltage is coupled to an energy source associated with the energy harvesting circuit.

13. A computing device coupled to an energy harvesting circuit, comprising:
one or more processors; and
a memory storing instructions for execution by the one or more processors, wherein execution of the instructions causes the computing device to perform operations comprising:
identifying a first time period required for the energy harvesting circuit to complete a first number of energy extraction events, the first time associated with an initial harvest voltage;
determining a first value of an estimated extracted power based on the initial harvest voltage and the first number of energy extraction events; and
iteratively adjusting the harvest voltage and determining the optimal harvest voltage based at least in part on values of the estimated extracted power value corresponding to the adjusted harvest voltage.

14. The computing device of claim 13, wherein execution of the instructions for iteratively adjusting the harvest voltage causes the computing device to perform operations further comprising:
incrementing the harvest voltage by a predetermined value;
identifying a second number of energy extraction events occurring within the first time period, the second number of energy extraction events based on the incremented harvest voltage;
determining a second value of the estimated extracted power based on the incremented harvest voltage; and
determining the optimal harvest voltage based at least in part on the second value of the estimated extracted power.

15. The computing device of claim 14, wherein execution of the instructions for determining the optimal harvest voltage causes the computing device to perform operations further comprising:
if the second value of the estimated extracted power exceeds the first value of the estimated extracted power, further incrementing the incremented harvest voltage by the predetermined value, wherein the optimal harvest voltage is determined based at least in part on the further incremented harvest voltage.

16. The computing device of claim 14, wherein execution of the instructions for determining the optimal harvest voltage causes the computing device to perform operations further comprising:
if the second value of the estimated extracted power is less than the first value of the estimated extracted power, decrementing the incremented harvest voltage by twice the predetermined value, wherein the optimal harvest voltage is determined based at least in part on the twice decremented harvest voltage.

17. The computing device of claim 16, wherein execution of the instructions causes the computing device to perform operations further comprising:
determining a third value of the estimated extracted power based at least in part on the twice decremented harvest voltage; and
comparing the third value of the estimated extracted power to the second value of the estimated extracted power.

18. The method of claim 17, further comprising:
in response to the third value of the estimated extracted power exceeding the second value of the estimated extracted power, incrementing the twice decremented harvest voltage by the predetermined value and identifying the incremented twice decremented harvest voltage as the optimal harvest voltage.

19. The computing device of claim 17, wherein execution of the instructions causes the computing device to perform operations further comprising:
in response to the second value of the estimated extracted power exceeding the third value of the estimated extracted power, further decrementing the twice decremented harvest voltage;
determining a fourth value of the estimated extracted power based at least in part on the further decremented harvest voltage, wherein the optimal harvest voltage is determined based at least in part on the fourth value of the estimated extracted power.

20. A non-transitory computer-readable storage medium storing instructions for execution by one or more processors of a computing device coupled to an energy harvesting circuit, wherein execution of the instructions causes the computing device to perform operations comprising:
identifying a first time period required for the energy harvesting circuit to complete a first number of energy extraction events, the first time associated with an initial harvest voltage;
determining a first value of an estimated extracted power based on the initial harvest voltage and the first number of energy extraction events; and
iteratively adjusting the harvest voltage and determining the optimal harvest voltage based at least in part on values of the estimated extracted power value corresponding to the adjusted harvest voltage.
